(19) United States
(12) Patent Application Publication
(10) Pub. No.: US 2015/0154357 A1
(43) Pub. Date: Jun. 4, 2015

(54) METHOD AND APPRATUS FOR DETERMINING CONSENT TO ACCESS MEDICAL DATA BASED ON AN AGGREGATE REPONSE

(71) Applicant: Nokia Corporation, Espoo (FI)

(72) Inventors: Debmalya BISWAS, Lausanne (CH); Julian NOLAN, Pully (CH); Matthew John LAWRENSON, Bussigny-pres de-lausanne (CH)

(73) Assignee: Nokia Corporation, Espoo (FI)

(21) Appl. No.: 14/093,170

(22) Filed: Nov. 29, 2013

(51) Int. Cl. G06F 19/00

(52) U.S. Cl. CPC G06F 19/322

(57) ABSTRACT

An approach for determining consent to access medical data based on an aggregate response. The group consent platform processes a response from each user of a subset of one or more users, one or more user privacy settings, one or more group privacy settings, or a combination thereof to determine a privacy policy for the subset. The subset is from a group of one or more users sharing a common genealogical relationship in response to a notification from a user from the group requesting consent to access medical data related to at least one test genetic test characteristic. The group consent platform then determines an aggregate response for the subset from the response from each user of the subset based on the privacy policy. The group consent platform also processes the aggregate response to determine whether the subset consented to access the medical data.

### BACKGROUND

With the rising computation power coupled with breakthroughs in genetic sequencing techniques, genetic testing and screening have recently become more affordable and mainstream. Genetic data can reveal personal sensitive information because it can reveal may aspects of an individual's life such as diseases, sensitivity to allergies susceptibility to toxins, psychological issues, etc. It can also potentially reveal sensitive information about the individual's family members depending on the genetic test. Additionally, genetic data about the individual's family members can also impact the analysis of the individual's and individual family members' genetic data, for example, with respect to diseases. As a result, there is a need to determine privacy of a genetic data at a group level to protect the privacies associated with the genetic data associated with each individual of the group of individual's family members.

### Some Example Embodiments

Therefore, there is a need for an approach for determining consent to access medical data based on an aggregate response for a subset of one or more family members affected by a genetic test.

According to one embodiment, a method comprises processing of a response from each user of a subset of one or more users, one or more user privacy settings, one or more group privacy settings, or a combination thereof to determine a privacy policy for the subset. The subset is from a group of one or more users sharing a common genealogical relationship in response to a notification from a user from the group requesting consent to access medical data related to at least one test genetic test characteristic. The method also comprises determining an aggregate response for the subset from the response from each user of the subset based on the privacy policy. The method further comprises determining an aggregate response for the subset from the response from each user of the subset based on the privacy policy.

According to another embodiment, an apparatus comprises at least one processor, and at least one memory including computer program code for one or more computer programs, the at least one memory and the computer program code configured to, with the at least one processor, cause, at least in part, the apparatus to process a response from each user of a subset of one or more users, one or more user privacy settings, one or more group privacy settings, or a combination thereof to determine a privacy policy for the subset. The subset is from a group of one or more users sharing a common genealogical relationship in response to a notification from a user from the group requesting consent to access medical data related to at least one test genetic test characteristic. The apparatus is further caused to determine an aggregate response for the subset from the response from each user of the subset based on the privacy policy. The apparatus is further cased to determine an aggregate response for the subset from the response from each user of the subset based on the privacy policy.

According to another embodiment, a computer-readable storage medium carries one or more sequences of one or more instructions which, when executed by one or more processors, cause, at least in part, an apparatus to process a response from each user of a subset of one or more users, one or more user privacy settings, one or more group privacy settings, or a combination thereof to determine a privacy policy for the subset. The subset is from a group of one or more users sharing a common genealogical relationship in response to a notification from a user from the group requesting consent to access medical data related to at least one test genetic test characteristic. The apparatus is further caused to determine an aggregate response for the subset from the response from each user of the subset based on the privacy policy. The apparatus is further cased to determine an aggregate response for the subset from the response from each user of the subset based on the privacy policy.

According to another embodiment, an apparatus comprises means for processing a response from each user of a subset of one or more users, one or more user privacy settings, one or more group privacy settings, or a combination thereof to determine a privacy policy for the subset. The subset is from a group of one or more users sharing a common genealogical relationship in response to a notification from a user from the group requesting consent to access medical data related to at least one test genetic test characteristic. The apparatus also comprises means for determining an aggregate response for the subset from the response from each user of the subset based on the privacy policy. The apparatus further comprises means for determine an aggregate response for the subset from the response from each user of the subset based on the privacy policy.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining consent to access medical data associated with at least one genetic test characteristic based on an aggregate response, according to one embodiment;

FIG. 2 is a diagram of the components of group consent platform 107, according to one embodiment;

FIG. 3 is a flowchart of a process for determining consent to access to medical data associated with at least one genetic test characteristic based on an aggregate response for a subset of one or more users, according to one embodiment;

FIG. 4 is a flowchart of a process for determining the aggregate response for the subset of one or more users, according to one embodiment;

FIG. 5 is a flowchart of a process for determining a subset of one or more users based on a request related to at least one genetic test characteristic from a user of the group, according to one embodiment;

FIG. 6 is a flowchart of a process for causing, at least in part, a notification to be transmitted to each user of the subset, according to one embodiment;

FIG. 7 is a diagram of a user interface utilized in the process of generating a notification in response to an individual's request to access data for at least one genetic test characteristic and causing, at least in part, a transmission of the notification to a subset of one or more users, according to one example embodiment;

FIG. 8 is a diagram of a user interface utilized in the process of generating a response and causing, at least in part, a transmission of a response from a user of a subset of one or more users to the notification, according to one example embodiment;

FIG. 9 is a diagram illustrating the processing of a response from each user of a subset, according to embodiment

FIG. 10A is a diagram of a user interface utilized in the process of providing access to the medical data for each user of the subset based on the aggregate response of the subset, according to one example embodiment and FIG. 10B is a diagram of a user interface utilized in the process of providing access to the medical data of the user that requested access to the medical data of the subset, according to one example embodiment;

FIG. 11 is a diagram of a user interface utilized in the process of denying access to the medical data for each user of the subset based on the aggregate response of the subset, according to one example embodiment;

FIG. 12 is a diagram of hardware that can be used to implement an embodiment of the invention;

FIG. 13 is a diagram of a chip set that can be used to implement an embodiment of the invention; and

FIG. 14 is a diagram of a mobile terminal (e.g., handset) that can be used to implement an embodiment of the invention.

### DESCRIPTION OF SOME EMBODIMENTS

Examples of a method, apparatus, and computer program for determining consent to access medical data related to a genetic test characteristic based on an aggregate response are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

With the recent developments in genetic sequencing techniques, more genetic tests are becoming increasingly available helping genetic data to become an informative medical tool in the diagnosis, prevention, and treatment of disease for an individual. By its nature, testing and/or analysis genetic data can have the same clinical or reproductive implications on one or more family members as the individual family member requesting the test because much genetic data is common between family members. Many informed consents for genetic testing request acknowledgment of the family impact and some organizations try to involve the family in the informed consent process. Additionally, medical data (e.g., genetic data, family history, etc.) of one or more family members can be useful in analyzing the genetic data and/or genetic testing of an individual. As a result, there is a need to determine consent to access medical data related to a genetic for those family members affected by a genetic test and/or analysis.

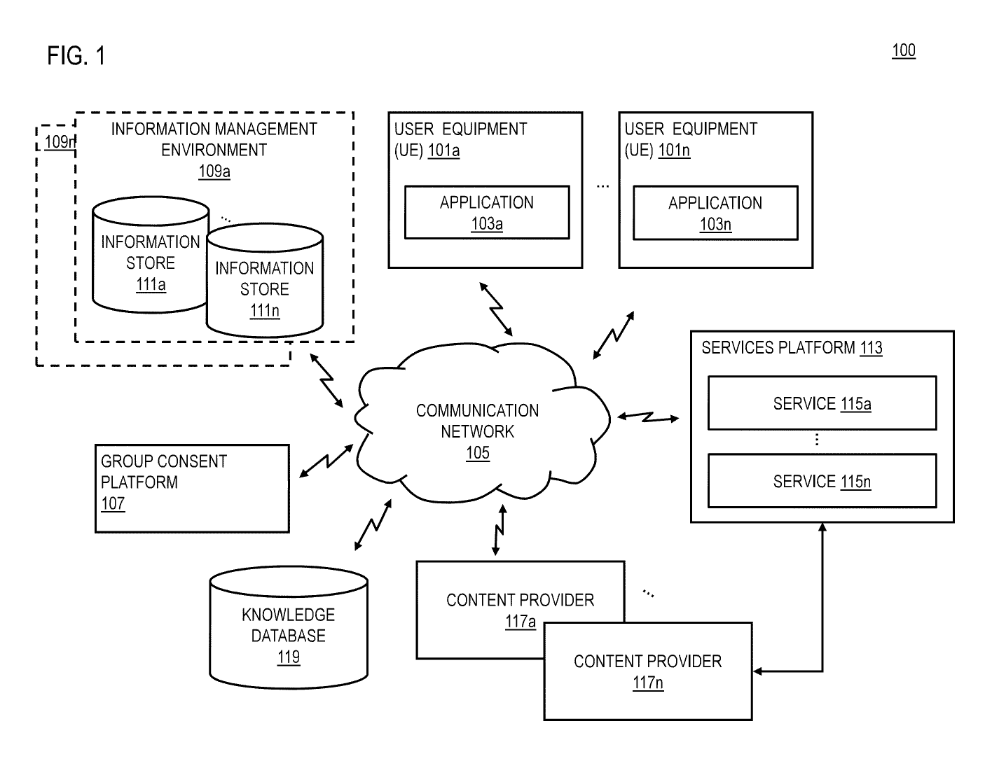

To address this problem, a system 100 of FIG. 1 introduces the capability to determine consent to access medical data associated with at least one genetic test characteristic based on an aggregate response for a subset of one or more users. As shown in FIG. 1, the system 100 comprises user equipment (UEs) 101a-101n (collectively referred to as UE 101) that may include or be associated with applications 103a-103n (collectively referred to as applications 103). In one embodiment, the UE 101 have connectivity to a group consent platform 107 via a communication network 105. In one embodiment, the group consent platform 107 performs one or more functions associated with determining consent to access medical data associated with at least one genetic test characteristic based on the aggregate response for a subset of one or more users.

By the way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that is executable at the UE 101, such as, media applications (e.g., music and/or video streaming, photo exchange, etc.), social networking applications, content provisioning services, location-based services (e.g., providing proximity information), an internet browser, a contact application, other client programs (e.g., calendar applications, Internet browsing applications, etc.) and the like. In one embodiment, one of the applications 103 at the UE 101 may act as a client for the group consent platform 107 and perform one or more functions associated with the functions of the group consent platform 107. In one embodiment, the group consent platform 107 may interface with the applications 103 on the UE 101 to perform one or more functions described herein.

In one embodiment, the group consent platform 107 may include or have access to one or more information management environments 109a-109n (also collectively referenced to as information management environments 109). By way of example, the information management environment 109 can include one or more information stores 111a-111n (collectively referred to as information stores 111). The information stores 111 may contain, for instance, group information related to the one or more users of the group and respective relationships, contact information for one or more users of the group, one or more user privacy settings for one or more users of the group (e.g., encryption keys, confidentiality requirements, etc.), medical data for one or more users of the group, group privacy settings (e.g., default encryption modes, preferred degrees of defined relationship, confidentiality requirements etc.), or a combination thereof.

In one embodiment, the group information may include a group of one or more users that share a common genealogical relationship and the respective relationships of the one more users within the group (e.g., a family tree). In some embodiments, the group information may include one or more group privacy settings.

In one embodiment, the medical data may include, for instance, genetic data of a user, medical history data of a user, and/or a combination thereof. In some embodiments, the genetic data may include annotated genomic data, such as a list of sequence variations (SNPs) with structural and/or functional annotation for any identified genomic element. For example, an identified genomic element(s) may be annotated with mutations and gene names, the medical conditions detections that can be detected based on the testing and/or analyzing those elements, among others, or a combination thereof.

In one embodiment, the information stores 111 can contain information in encrypted form. In some embodiments, the information contained on the information stores 111 can be stored on a local storage on the UE 101, on a storage of the group consent platform 107, on the information management environments 109, or a combination thereof. For example, the contacts information may be retrieved from an address book on UE 101 of the requestor and the medical data may be stored on the UE 101 of the respective user of the group.

In one embodiment, the group consent platform 107 may include or have access to a knowledge database 119. The knowledge database may store a plurality of genetic test characteristics and related test information. A genetic test characteristic refers to one or more disorders/diseases, the related genetic tests, or a combination thereof. The test information may include one or more defined relationships; one or more sequence variations relevant to the genetic test characteristic; test results (e.g., possible results, implications of results, etc.) and privacy consequences of the results if consent to the medical data is approved (e.g., genetic discrimination such as employment and health insurance discrimination, etc.). In some embodiments, the test information may include other information according to genetic testing guidelines so as to provide an “informed” consent.

The one or more defined relationships can relate to the one or more relationships of the group that may be affected by and/or affect the analysis, testing, or a combination thereof of medical data associated with at least one genetic test characteristic. The one or more defined relationships may relate to a degree of relationship, one or more lineages (e.g., maternal and/or paternal), or a combination thereof.

In some embodiments, the knowledge database 119 may be updated as information regarding new tests and current tests becomes available. In some embodiments, the information contained on the knowledge database 119 can be stored can be stored on a local storage on the UE 101, on a storage of the group consent platform 107, on the information management environments 109, or a combination thereof.

In one embodiment, the group consent platform 107 can process at least one request for consent to access medical data related to at least one genetic test characteristic from a user of the group sharing a common genealogical relationship. By way of example, access to medical data can include access to medical data of one or more users of a subset and/or user requesting access for analyzing and/or testing the medical data for at least one test characteristic, access to share the medical data relevant to the at least one test characteristic, among others, or a combination thereof. The group consent platform 107, for instance, can determine the subset of one or more users from the group corresponding to the one or more defined relationships based on the at least genetic test characteristic, one or more group privacy settings, or a combination thereof. For example, if a user is interested in requesting consent to access medical data for analysis/testing for breast cancer, breast cancer is associated with both BRCA1 gene and BRCA2 gene. The group consent platform 107 can access the knowledge database to determine the one or more defined relationships corresponding to the BRCA1 gene and the BRCA2 gene. BRCA1 and BRCA2 mutations can be inherited by females and males and passed to their offspring. The one or more defined relationships may include those users on both the maternal and fraternal sides. In a further example, if the defined relationships in the knowledge database and/or the group privacy settings include a degree of relationship parameter, for example, the degree of relationship parameter is 3, then one more defined relationships include any of the following with respect to the user requesting access: parents, children, siblings, aunts/uncles, grandparents, great-grandparents, nephews, nieces, grandchildren, and/or great-grandchildren.

In some embodiments, the subset of affected users may be further divided into subgroups of one or more members of the larger subset. In yet another embodiment, the system 100 may arrange the subgroups into hierarchical relationships within the subset, wherein each subgroup can be associated with respective privacy settings, preferences, rights, consent privileges, etc. The subgroups may also function independently or collectively to reach a global consensus the subset as a whole. Although some of the various embodiments described herein discuss consent management with respect to the entire subset or group of affected users (e.g., affected family members), it is contemplated that the embodiments apply also to subgroups defined within the larger subset or group.

In one embodiment, the group consent platform 107 may process and/or facilitate a processing of contact information stored in the address book of the UE 101 and/or the information stores 111 to determine the contact information for each user of the subset and/or subgroups of the subset. In some embodiments, the contact information for a user may include respective one or more user privacy settings (e.g., public encryption key). In other embodiments, the one or more user privacy settings may be stored separately in the information stores 111.

In one embodiment, the group consent platform 107 may cause a notification to be sent to each user of the subset and/or subgroups using the corresponding contact information. In some embodiments, the notification may include test information from the knowledge database 119.

In one embodiment, the group consent platform 107 may encrypt the notification using the one or more user privacy settings. For example, the notification may be encrypted using the public key associated with the contact information of the user or subgroup of users.

In one embodiment, the group consent platform 107 can process a response to the notification for each user of the subset to determine an aggregate response for the subset or subgroup from the response from each user. The aggregate response can indicate whether access to the medical data has been consented by the subset, subgroup, or combination thereof.

In one embodiment, the notified users may provide respective responses to the notification independently. For example, individual users can provide or deny consent directly without consulting each other. In another embodiment, the system 100 provides collective or joint responses to be submitted from the users. For example, one of the affected family members may consult with another affected member to reach a joint response to submit to the system 100. In some embodiments, affected members may be arranged into the subgroups noted above for purposes of receiving joint notifications and/or providing joint consents. These subgroups, for instance, are formed to take on subgroup level decisions. In yet other embodiment, the subgroups may be arranged into a hierarchical structures whereby a first hierarchy of one or more subgroups first reach decisions or make responses, which are then aggregated to reach a global decision or response for the entire subset of “all affected family members” for a data sharing request.

In one embodiment, the group consent platform 107 may determine the aggregate response from reach response based on the privacy policy for the subset and/or subgroups within the subset. The privacy policy for the subset can relate to maintaining confidentiality of responses and/or identity of respective users, encryption methods, among others, or a combination thereof. In some embodiments, the group consent platform 107 may determine the privacy policy for the subset based on the response to the notification from each user of the subset, one more user privacy settings for each user of the subset, one or more privacy settings for the group, or a combination thereof. For example, the one more or user privacy settings and/or one more private settings for the group may include privacy settings to maintain confidentiality of responses and/or identity of respective users under all conditions (positive and/or negative aggregate response). By way of another example, the one more or user privacy settings and/or one more private settings for the group may include one or more privacy settings to maintain confidentiality of responses and/or identity of respective users if there is a negative aggregate response (e.g., at least one of the responses from a user of the subset was negative). In this way, abuse and/or bias by (i) the user requesting consent to access and/or share medical data and/or (ii) other users (e.g., other family members).

In one embodiment, the group consent platform 107 may determine a response value for a response from each user of the subset and/or collectively for a subgroup within the subset, and an aggregate response value for the subset from the response value from each user and/or subgroup within the subset. In some embodiments, the determination of the response value and aggregate response value may be based on the whether the received responses are encrypted. For example, if the responses are not encrypted, the response value and the aggregate response value may be determined in terms of a Boolean flag (“Yes” or “No”) and sends the aggregate response value as the aggregate response to the device of the user requesting access.

In one embodiment, if the received responses are encrypted, the group consent platform 107 may determine the response value and the aggregate response value directly from the encrypted responses. In some embodiments, the group consent platform 107 may use advanced encryption techniques, such as homomorphic encryption.

In one embodiment, the group consent platform 107 may determine the response value and aggregate response value using a protocol as follows:

DEC_{H}(ENC_{H}(a)×ENC_{H}(b))=a+b

In this protocol, ENC_{H} and DEC_{H} denote the homomorphic encryption and decryption operation, respectively. In one scenario, each user of the subset responds with either “0,” which denotes a response giving consent, or “1,” which denotes a response denying consent. Each user of the subset can then encrypt their responses ENC_{H}(0/1), and send them to the group consent platform 107. In this scenario, the UE 101 of the user that requested access may perform one or more functions for determining consent associated with the group consent platform 107. Once all responses are received, the group consent platform 107, via the UE 101, can decrypt the sum of the responses from all users of the subset as follows:

s=DEC_{H}(ENC_{H}(0/1)×ENC_{H}(0/1)× . . . )

If the group consent platform 107 determines (s==0), then all users and/or subgroups of the subset have given consent and access can be granted. Otherwise, if the group consent platform 107 determines (s>0), then implies that one or more users/subgroups of the subset did not give consent and access can be denied. If so, the above protocol ensures the anonymity of those who did not give consent and thus can be protected from repercussions from the user requesting access and/or other users of the group.

In one embodiment, the group consent platform 107 may determine consent to access based on the aggregate response. For example, if the aggregate response was positive (all users and/or subgroups granted consent), the group consent platform 107 may provide the user that requested access consent to access the medical data. In some embodiments, the group consent platform 107 may cause the contact information of each user and/or subgroup of the subset to be retained so that a notification can be generated informing each user of the subset of the availability of the medical data related to the test results/analysis of the user that requested access. On the other hand, if the aggregate response was negative (at least one user and/or subgroup denied consent), the group consent platform 107 informs that the access the user requested has been denied. The group consent platform 107 can keep the identity of each user and/or subgroup of the subset concealed so that the user requested consent cannot identify the family members that denied his/her request.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The services platform 113 may include any type of service. By way of example, the services platform 113 may include social networking services, content (e.g., audio, video, images, etc.) provisioning services, application services, storage services, contextual information determination services, location based services, information (e.g., weather, news, etc.) based services, etc. In one embodiment, the services platform 113 may interact with the UE 101, the group content platform 107 and the content providers 117 to supplement or aid in the processing of a request to access medical data of a subset of one or more members of a group.

By way of example, services 115 may be an online service that stores confidential data (e.g., medical data, group information, etc.). The services 115 may additionally assist the group consent platform 107 in determining an aggregate response by processing the response from each user of the subset to further protect the privacy interest of the one or more users of the UE 101.

The content providers 117 may provide content to the UE 101, the group consent platform 107, and the services 115 of the services platform 113. The content provided may be any type of content, such as textual content, audio content, video content, image content, etc. In one embodiment, the content providers 117 may provide content that may supplement content of the applications 103. By way of example, the content providers 117 may provide content that may aid the group consent platform 107 in determining test information associated with the genetic test characteristic. In one embodiment, the content providers 117 may also store content associated with the UE 101, the group consent platform 107, the knowledge database 119 and the services 115 of the services platform 113. In another embodiment, the content providers 117 may manage access to a central repository of data, e.g., the information stores 111, and offer a consistent, standard interface to user's data.

By way of example, the UE 101, the group consent platform 107, the services platform 113, and the content providers 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

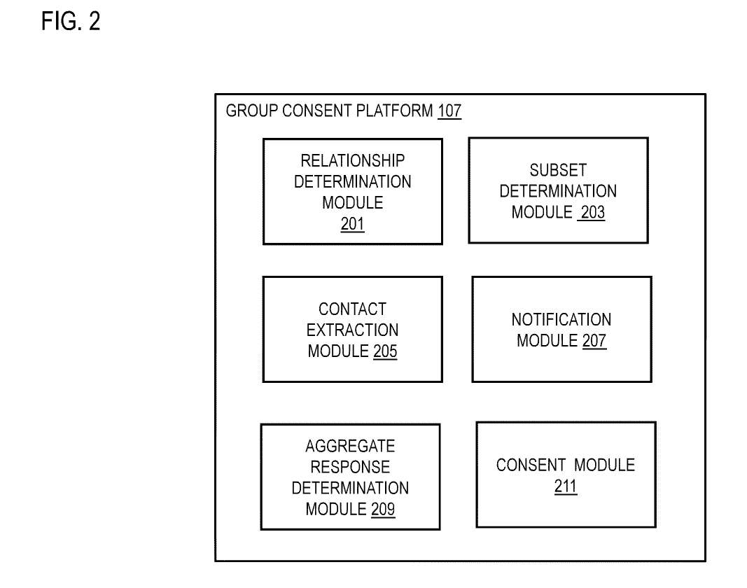

FIG. 2 is a diagram of the components of the group consent platform 107 according to one embodiment. By way of example, the group consent platform 107 includes one or more components for determining consent to access medical data associated with a genetic test characteristic based on an aggregate response for a subset. It is contemplated that the functions of these components may be combined in one or more components or performed by other components of equivalent functionality. In this embodiment, the group consent platform 107 includes a relationship determination module 201, a subset determination module 203, a contact extraction module 205, a notification module 207, an aggregate response determination module 209 and a consent module 211.

In one embodiment, the relationship determination module 201 may process or facilitate processing of a request for consent to access medical data from one of the users of the group to determine one or more defined relationships for at least one test characteristic. In one embodiment, the relationship determination module 201 may determine the one or more defined relationships by querying the knowledge database 119 with the genetic test characteristic as a parameter to retrieve the one or more defined relationships.

In one embodiment, the subset determination module 203 may process or facilitate processing the one or more defined relationships with respect to the group database to determine a subset of one more users corresponding to the one or more defined relationships. For instance, if the one or more defined relationships correspond to female(s) on the maternal side, the subset determination module 203 may determine a subset of the one or more users corresponding to the material side (e.g., mother, sister, maternal grandmother, maternal aunts, etc.).

In one embodiment, if a user of the subset is deceased, another user may be associated with the deceased user. For example, if the grandmother is deceased, one of her children may have chosen or may have been chosen to receive notifications and have authorization to provide access to and/or share the medical data of the deceased user. In some embodiments, the replacement user may be stored with the group. In some embodiments, the one or more group privacy settings may include an automatic response to a notification for request consent. For example, the one or more group privacy settings may indicate that consent for access is always granted to a notification.

In one embodiment, the contact extraction module 205 may cause or facilitate causing the retrieval of contact information corresponding to the subset of one or more users from a contact information database, for example, stored on UE 101 and/or information stores 111. In one embodiment, the contact information may include one or more user privacy settings (e.g., public key) for each user. In other embodiments, the contact extraction module 205 may cause or facilitate causing the retrieval of the private policy preference for each user from another database.

In one embodiment, the notification module 207 may process or facilitate the processing of the at least one test characteristic, the one or more user privacy settings, or a combination, thereof to generate a notification to be sent to a user of the subset. In some embodiments, the notification module 207 may process the at least one genetic test characteristic to determine the test information related to the at least one genetic test characteristic to include in the notification requesting consent. For example, for mitochondria disorders, the test information may include the genetic test/data analysis to be performed; a list of disorders associated with mitochondria genes; the list of one or more sequence variations associated with the disorders; possible test results and explanation; and privacy consequences associated with genetic testing of mitochondria disorders.

In one embodiment, the notification module 207 may cause or facilitate causing the transmitting a notification requesting consent to each user of the subset using the contact information and one or more user privacy settings. In one embodiment, the notification module 207 may encrypt the notification with the respective public key for the user before transmitting.

In one embodiment, the notification may include a response link to direct the response (e.g., granting or denying access) to an address specified by the user requesting consent. For instance, the response link may cause or facilitate causing the response to be sent to a user device of the user requesting consent. In some embodiments, the response link may direct the response to the group consent platform 107 for processing before causing or facilitate causing the response to be transmitted to and/or displayed on the user device of the user requesting consent.

In one embodiment, the aggregate response determination module 209 may process or facilitate a processing of the response to the notification from each user of the subset. In one embodiment, the aggregate response determination module 209 may process or facilitate the processing of the response to the notification from each user of the subset based on the privacy policy for the subset. In one embodiment, the aggregate response determination module 209 may process a response to the notification from each user of the subset, one or more user privacy settings for each user of the subset, one or more privacy settings for the group, or a combination thereof to determine a privacy policy for the subset. In one embodiment, the aggregate response determination module 209 may determine that the responses and/or respective users of the subset be concealed. For example, the one or more privacy settings for the group may indicate that the aggregate response determination module 209 must conceal the identity of all users of the subset and/or responses. In another example, if the one or more privacy settings for the group indicate that if any response from a user of the subset to a notification is negative (no consent), the aggregate response determination module 209 must conceal the identity of all users of the subset and/or responses. In yet another example, if one or more user settings for a user of the subset indicate that if a response from that user to a notification is negative (no consent), the aggregate response determination module 209 must conceal the identity of that user and response; and therefore the group consent platform 107 must conceal the identity of all users of the subset and/or responses. In this way, by keeping the subset of the users and/or responses by the users anonymous, the abuse and/or bias by the user requesting the consent and/or other family members may be avoided.

In one embodiment, the aggregate response determination module 209 may delay or facilitate the delay in processing the responses of the users of the subset until the responses of all users has been received. In one embodiment, the aggregate response determination module 209 may determine an aggregate response to the notification based on the privacy policy for the subset.

In one embodiment, the aggregate response determination module 209 may process or facilitate processing a response to the notification from each user of the subset to determine a response value. In one embodiment, the response value may be a logical value. For instance, a value of “0” may correspond to a response of “consent” and value of “1” may correspond to a response of “no consent.”

In one embodiment, the aggregate response determination module 209 may process or facilitate processing each response value from each user of the subset to determine an aggregate response value for the subset. By way of example, if any of the response values indicate “no consent,” then the aggregate response value can indicate “no consent.” On the other hand, if all response values indicate “consent” then the aggregate response value can indicate “consent.”

In one embodiment, the aggregate response determination module 209 may cause the aggregate response value to be transmitted and/or displayed on the device of the user requesting consent as the aggregate response according to the privacy policy of the subset. In some embodiments, the aggregate response determination module 209 may also process or facilitate the processing of the aggregate response value to determine a privacy policy for the subset. The aggregate response value can indicate whether there are any negative responses (“no consent”) to the notification. For example, if the one or more group policy settings and/or user privacy settings indicate that the responses be confidential if a negative response has been received and the aggregate response value indicates that at least one of the users responded negative to the request, the aggregate response determination module 209 can determine that the responses and users be kept concealed. The aggregate response determination module 209 may also cause the aggregate response value (“no consent”) to be transmitted and/or displayed on the device of the user requesting consent as the aggregate response, with individual responses and users concealed.

In one embodiment, the consent module 211 may cause or facilitate causing access to the medical data, for example, stored locally on the UE 101 and/or stored on information stores 111 and managed by a service provider 115, to access medical data of each user of the subset by the user requesting consent, the medical data of the user requesting consent by each user of the subset, or a combination thereof, based on the aggregate response. For example, if the subset provides consent to access (i.e., all users of the subset provide consent to access), each user of the subset may be provided with consent to access the results of the genetic test and/or analysis performed for the user requesting access. In one embodiment, the notification module 207 may cause or facilitate causing a notification to be transmitted informing each user of the subset regarding the availability of the medical data of the user requesting consent after the genetic test and/or analysis is performed.

The above presented modules and components of the group consent platform 107 can be implemented in hardware, firmware, software, or a combination thereof. Though depicted as a separate entity in FIG. 1, it is contemplated that the group consent platform 107 may be implemented for direct operation by respective UE 101. As such, the group consent platform 107 may generate direct signal inputs by way of the operating system of the UE 101 for interacting with the application 103. In another embodiment, one or more of the modules 201-211 may be implemented for operation by respective UEs, as the group consent platform 107, or combination thereof. Still further, the group consent platform 107 may be integrated for direct operation with the services 115, such as in the form of a widget or applet, in accordance with an information and/or subscriber sharing arrangement. The various executions presented herein contemplate any and all arrangements and models.

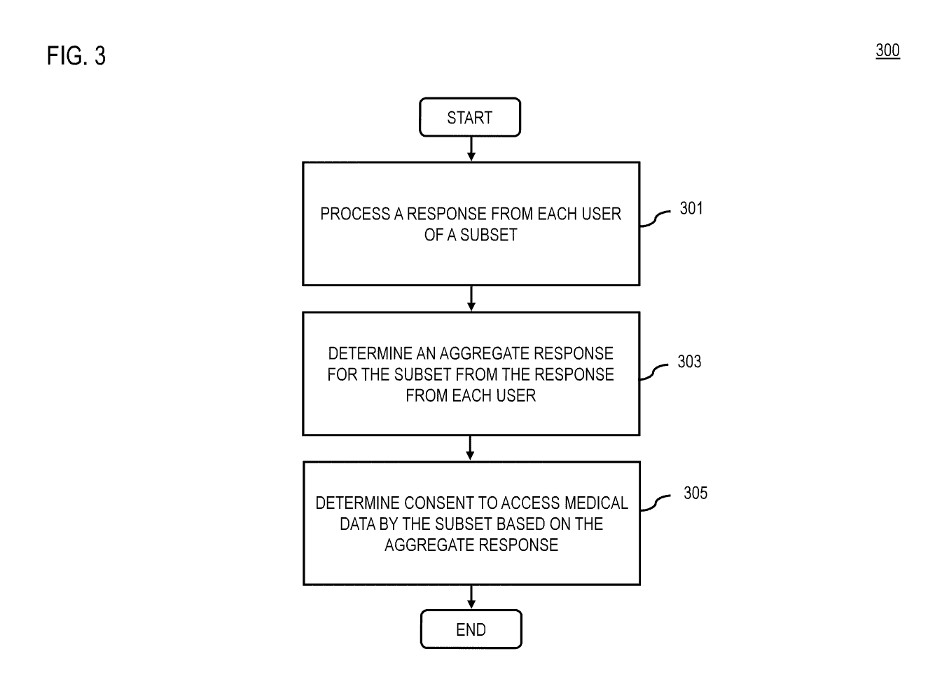

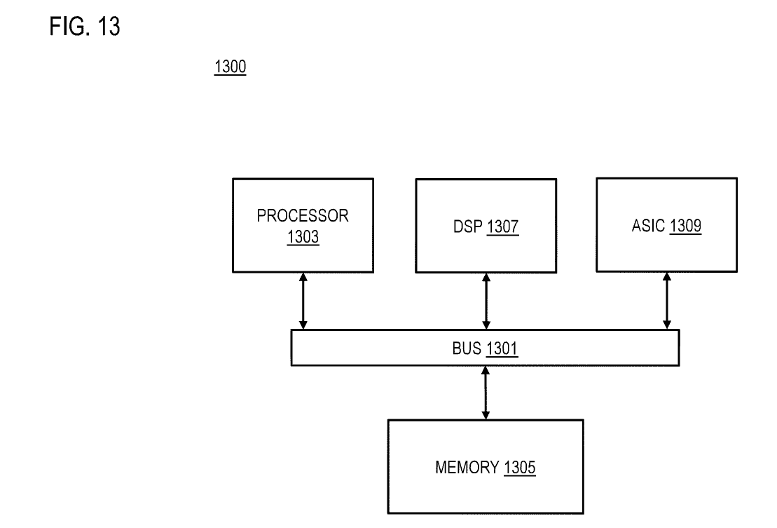

FIG. 3 is a flowchart of a process for determining consent to access medical data associated with at least one genetic test characteristic based on an aggregate response for a subset of one or more users, according to one embodiment. In one embodiment, the group consent platform 107 performs the process 300 and is implemented in, for instance, a chip set including a processor and a memory as shown in FIG. 13.

In step 301, the group consent platform 107 processes a response from each user of a subset to a request to access medical data related to at least one genetic characteristic, one or more user privacy settings, the one or more privacy settings for the group to determine a privacy policy for the subset. In one embodiment, the privacy policy for the subset can relate to can relate to maintaining confidentiality of responses and/or identity of respective users, encryption methods, among others, or a combination thereof. In some embodiments, the group consent platform 107 may cause all responses from the users of the subset and respective identities confidential.

In step 305, the group consent platform 107 determines an aggregate response for the subset from each response based on the privacy policy for the subset. In some embodiments, the group consent platform 107 may determine an aggregate response after the responses from all users of the subset have been received. For example, if the privacy policy for the subset indicates that the users and/or responses be kept confidential if any response is negative (does not give consent), the group consent platform 107 may then process each response so to maintain confidentiality. In one scenario, the group consent platform 107 may process each response according to a protocol to determine a logical value and determine an aggregate response from arithmetic sum of those values.

In step 307, the group consent platform 107 can process the aggregate response for the subset to determine the subset consented to access the medical data. In one embodiment, if the aggregate response is based on a response providing consent from each user of the subset, the aggregate response indicates that consent has been granted. If the aggregate response is based on at least one response denying consent from a user of the subset, then the aggregate response indicates that the consent has been denied. In some embodiments, the group consent platform 107 generates a notification to the user requesting access based on the aggregate response.

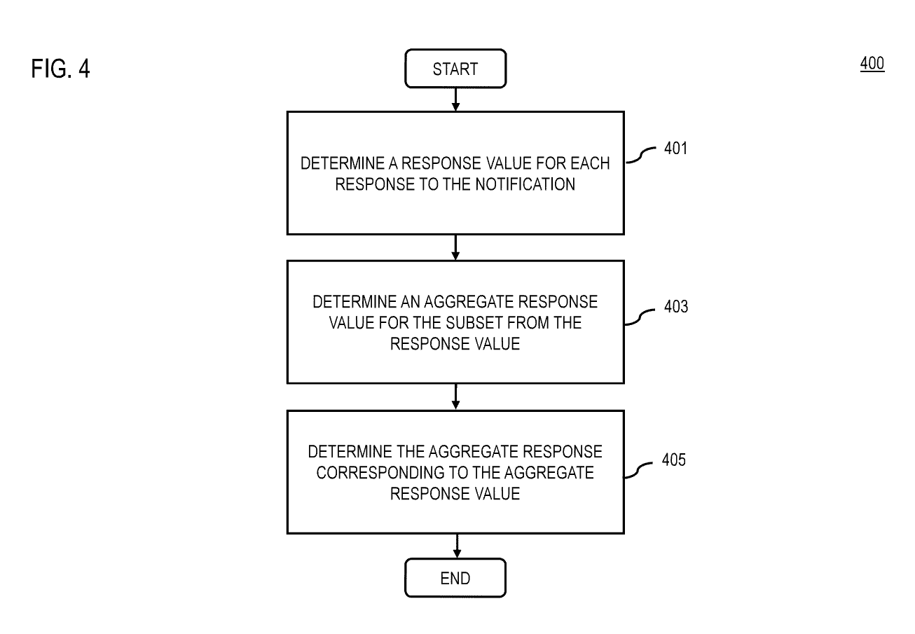

FIG. 4 is a flowchart of a process for determining the aggregate response for the subset of one or more users, according to one embodiment. In one embodiment, the group consent platform 107 performs the process 400 is implemented in, for instance, a chip set including a processor and a memory as shown in FIG. 13.

In step 401, the group consent platform 107 determines a response value for a response from each user of the subset. In one embodiment, the response value may correspond to a logical value. In some embodiments, the group consent platform 107 may determine the response values based on the privacy policy of the subset. For example, if one or more responses are encrypted and the privacy policy indicates that concealment of the users and respective responses, the group consent platform 107 may process the encrypted response directly to determine the response value, for example, using the protocol described above.

In step 403, the group consent platform 107 determines an aggregate response value for the subset from the response value of each user of the subset. In some embodiments, the group consent platform 107 will delay processing the aggregate response value until all responses from the subset have been received. In some embodiments, the aggregate response value may correspond to the sum of all response values for example, using the protocol above. For example, if all users of a subset provided consent, then the aggregate response value would correspond to a value of “0” under this protocol.

In step 405, the group consent platform 107 determines the aggregate response corresponding to the aggregate response value. For example, if the aggregate response value corresponds to a value of “0” under this protocol, then the aggregate response indicates that the subset provides consent to access the medical data requested.

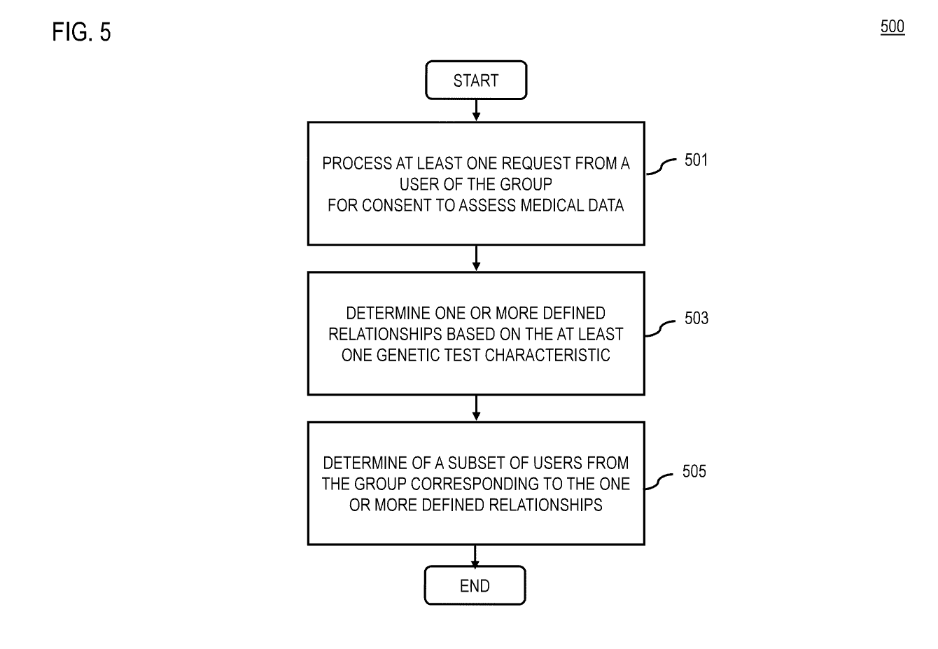

FIG. 5 is a flowchart of a process flow for determining a subset of one or more users based on a request related to at least one genetic test characteristic from a user of the group, according to one embodiment. In one embodiment, the group consent platform 107 performs the process 500 is implemented in, for instance, a chip set including a processor and a memory as shown in FIG. 13.

In step 501, the group consent platform 107 processes at least one request from a user of the group for consent to access medical data related to a genetic test characteristic. For example, the user from the group may be interested in genetic testing and/or screening for mitochondrial disorders. This user may cause the request to be transmitted by using the applications 103 on the UE 101. In one embodiment, the request can request consent to access and view medical data related to the genetic test characteristic of one or more users of the group, can request consent from the group for the user to undergo genetic testing and/or screening for genetic test characteristic on the user's personal medical data, among others, or a combination thereof.

In step 503, the group consent platform 107 determines one or more defined relationships based on the at least one genetic test characteristic. In one embodiment, the group consent platform 107 causes or facilities causing a query to the knowledge database 119 to determine the one or more defined relationships associated with the at least one genetic test characteristic. In the example above, the one or more defined relationships for mitochondria disorders correspond to females on the maternal side.

In step 505, the group consent platform 107 determines a subset of users from eth group corresponding to the one or more defined relationships. In one embodiment, the group consent platform 107 cross-references the one or more defined relationships to the group information to determine a subset of one or more users having the one or more defined relationships. By way of the example, the subset of one or more users corresponding to the one or more defined relationships related to mitochondria disorders includes the user's mother, sister, and grandmother.

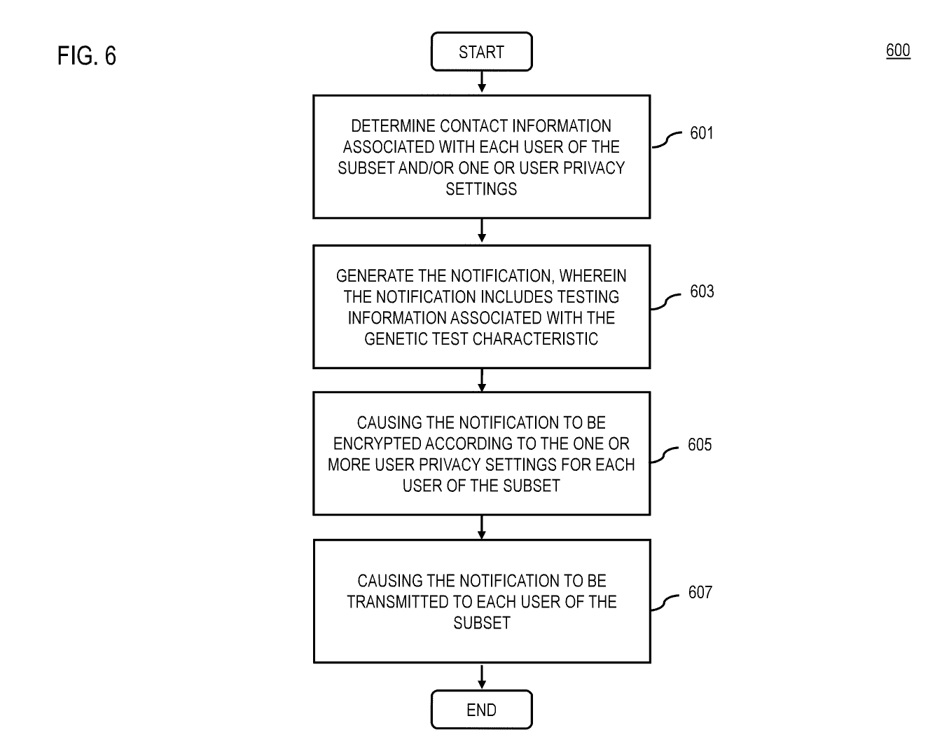

FIG. 6 is a flowchart of a process flow for causing, at least in part, a notification to be transmitted to each user of the subset based on the request, according to one embodiment. In one embodiment, the group consent platform 107 performs the process 600 is implemented in, for instance, a chip set including a processor and a memory as shown in FIG. 13.

In step 601, the group consent platform 107 determines contact information associated with each user of the subset, the one or more privacy settings for each user of the subset, or a combination thereof. In one embodiment, the contact information may include the one or more privacy settings for each user. The one or more privacy settings for each user, may include, for example, an encryption key for securely transmitting communications. In this way, any communications regarding medical data of the group are secure. In some embodiments, the group consent platform 107 may extract or cause the extraction of the contact information from the contacts stored locally on the UE 101 and/or the information stores 111 using the subset of one or more users determined from the group information, for example, in step 505 (FIG. 5).

In step 603, the group consent platform 107 may generate or cause the generation of a notification to be transmitted to each user of the subset. In one embodiment, the group consent platform 107 retrieves or causes the retrieval of test information associated with the at least one genetic test characteristic from the knowledge database 119 for inclusion in the notification. This way the users of the subset can provide an “informed” consent.

In step 605, the group consent platform 107 may cause the notification to be encrypted according to the one or more privacy settings for each user of the subset. For example, if the one or more privacy settings include an encryption key, the group consent platform 107 encrypts the notification with that key. This way, the data can be protected because the notification is sent to the UE 101 of each user of the subset.

In step 607, the group consent platform 107 can cause the notification to be transmitted to the UE 101 of each user of the subset.

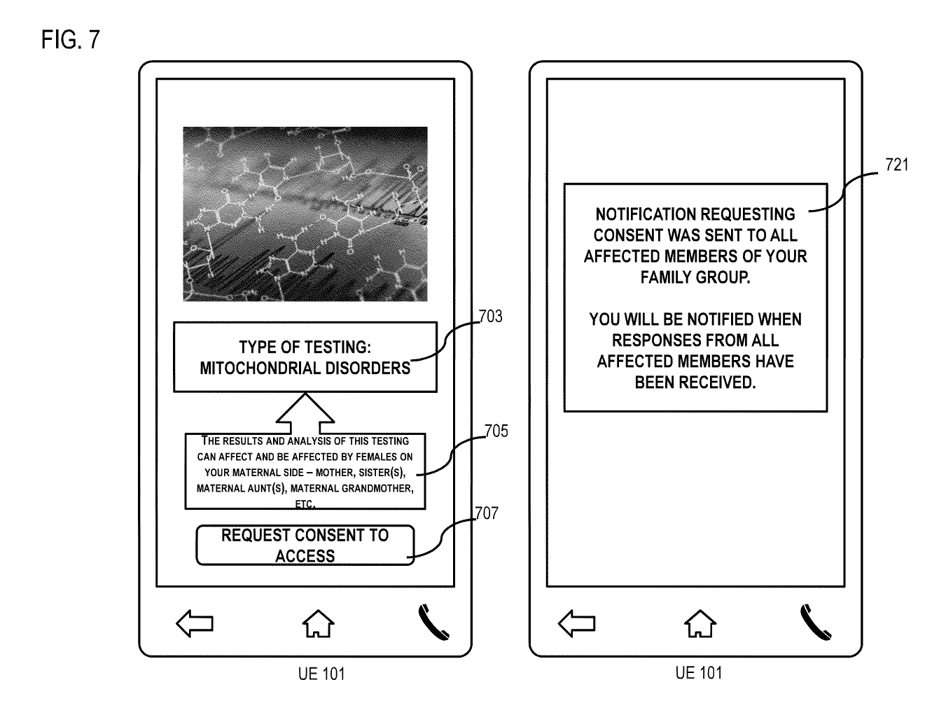

FIG. 7 is a diagram of a user interface utilized in the process of causing a notification to be transmitted to a subset of one or more users of a group based on the genetic test characteristic, according to one example embodiment. In this example, a user is interested in getting consent to access medical data associated with mitochondrial disorders or diseases [703]. In this scenario, the group consent platform 107 determined one or more defined relationships associated with mitochondrial disorders from the knowledge database 119 and caused those relationships to be displayed [705]. After reviewing the possible affected relationships, the user can cause the group consent platform 107 to generate and transmit a notification, for example, by clicking on the “Request Consent To Access” button [707]. Subsequently, the group consent platform 107 causes a notification to be transmitted to each affected member of the family based on the request. In this example, the group consent platform 107 provides confirmation [721] that the notifications were sent. The group consent platform 107 determines a subset of one or more member of the family group, determines contact information associated with each affected member, generates the notification, causes the notification to be encrypted according to one more user privacy settings associated with each affected member; and causes a notification to be transmitted to each affected member. In this example, the group consent platform 107 determines any females associated with the female side. Based on the group information, the group consent platform 107 causes a notification to be sent to the requestor's mother, sister, and grandmother. This way the notifications and corresponding responses can be managed by the group consent platform 107 and thus preserve the privacy of the subset.

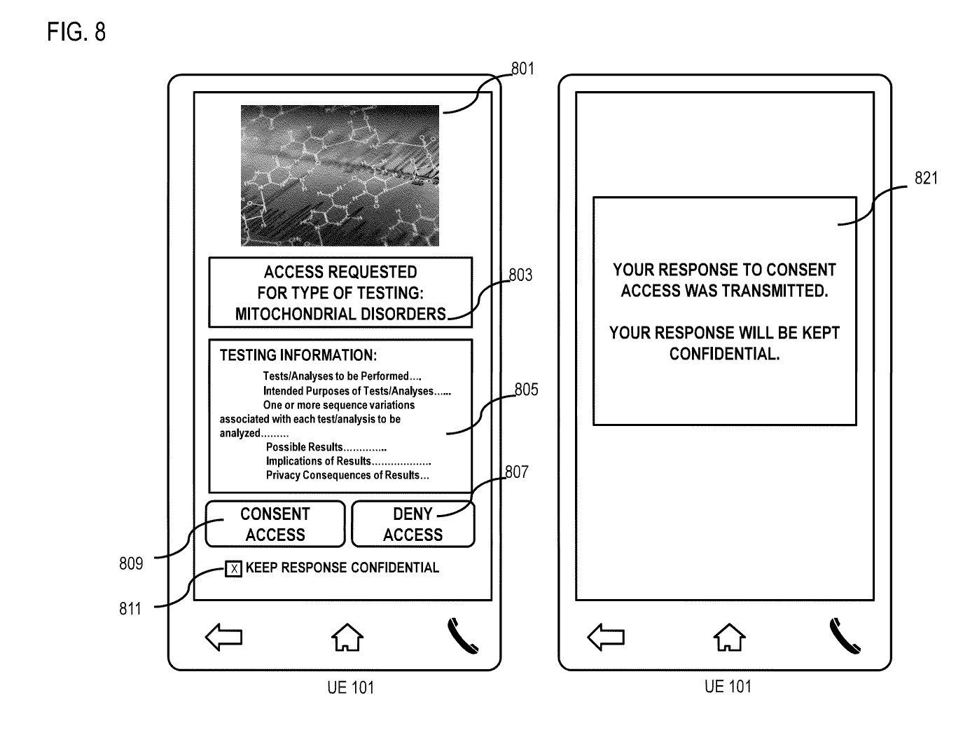

FIG. 8 is a diagram of a user interface utilized in the process of transmitting and responding to a notification, according to one example embodiment. In this example, one of the affected members with respect to the mitochondrial disorders or diseases received a notification [801] requesting consent to access that medical data associated with mitochondrial disorders. The group consent platform 107 retrieves the test information associated with the genetic test characteristic, in this example, mitochondrial disorders, from the knowledge database 119 for the notification. As shown in the notification [801], the least one genetic test characteristic requested is identified [803]. In addition, the test information determined by the group consent platform 107 and stored in the knowledge database 119 is provided [805]. In this way, the affected member can be informed when determining whether to provide consent to access the medical data. The notification [801] also includes the possible responses, grant access [809] or deny access [807]. Each of these responses are associated with a link to the group consent platform 107 so that the responses may be transmitted to the group consent platform 107 for processing while maintaining the confidentiality of the affected member and response. In this scenario, confidentiality of the group members is not automatic, and thus the notification [801] can include the option to keep the response confidential. After reviewing the possible implications of providing access, the user can cause a response to be transmitted to the group consent platform 107, for example, by clicking on the “Consent Access” button [809]. Subsequently, the response is transmitted to the group consent platform 107 for processing. In this example, the group consent platform 107 provides confirmation [821] that the response was sent.

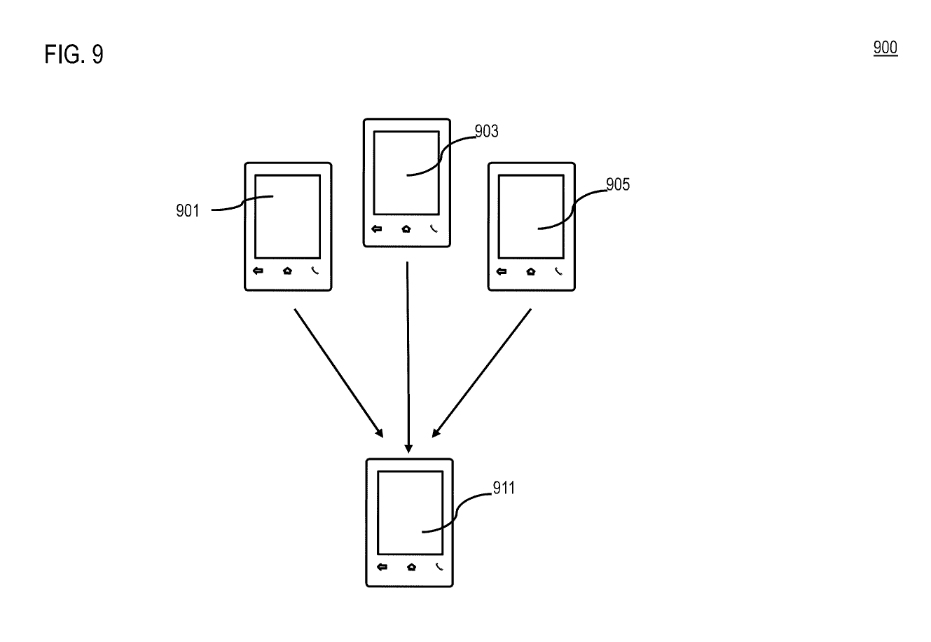

FIG. 9 is a diagram of the user interface utilized in the process of determining an aggregate response from the response from each user of the subset, according to one example embodiment. In this scenario, user interface [911] corresponds to the user interface (FIG. 7) that transmitted the request for access to medical data related to mitochondria disorders. The request was sent to user interfaces [901] (corresponding to interface of FIG. 8), [903], and [905], which correspond to user devices of the requestor's mother, sister, and maternal grandmother, respectively. In this example, the user interface 911 performs the processing of the responses from each interface to determine the aggregate response from each response transmitted from the user interfaces ([901], [903], and [905]) of the affected members based on the privacy policy for the subset. For example, the group consent platform 107 may generate direct signal inputs by way of the operating system of the UE 101 for interacting with the application 103 of the user interface 911. In this scenario, the privacy policy for the subset of affected members was at least determined by one of the affected members of the subset. The mother responded to the request for access with a request to keep the response confidential [811] in FIG. 8.

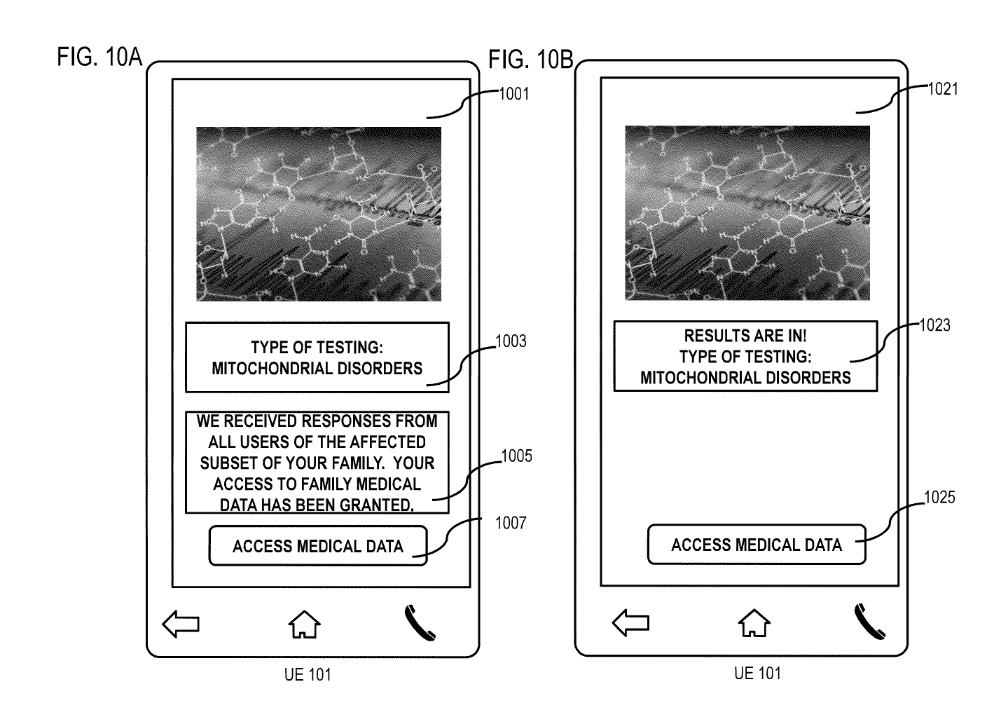

FIG. 10A is a diagram of the user interface utilized in the process of providing consent access to medical data to the user that requested access based on the aggregate response, according to one example embodiment. In this scenario, all affected family members positively responded to the request by consenting to access the medical data. As shown in FIG. 10A, the notification [1001] includes the results of the request [1005] with respect to the medical data requested for the genetic test characteristic [1003]. The user can access the medical data, for example, by clicking on the “Access Medical Data” button [1007]. In one example, the medical data may be stored locally on each 101. By clicking on the “Access Medical Data” button, the group consent platform 107 may cause or facilitate transmitting a request to the user interfaces ([901], [903], and [905]) of the affected members for the medical data. In other embodiments, the medical data may be stored contained in an information store 111 managed by a service provider 113 (e.g., a secure cloud data storage). By clicking on the “Access Medical Data” button, the group consent platform 107 may cause or facilitate transmitting a request to the service provider 113 for the medical data.

FIG. 10B is a diagram of the user interface of a user of the subset utilized in the process of providing notification of the availability of the results associated with the at least one genetic test characteristic, according to one example embodiment. In this example, the group consent platform 107 can cause a notification [1021] informing the availability of the results to be transmitted to the user interfaces ([901], [903], and [905]) of the affected members. The user can access the medical data, for example, by clicking on the “Access Medical Data” button [1025]. By clicking on the “Access Medical Data” button, the group consent platform 107 may cause or facilitate the retrieval of the medical data from the UE 101 of the user that requested access and/or an information store 111.

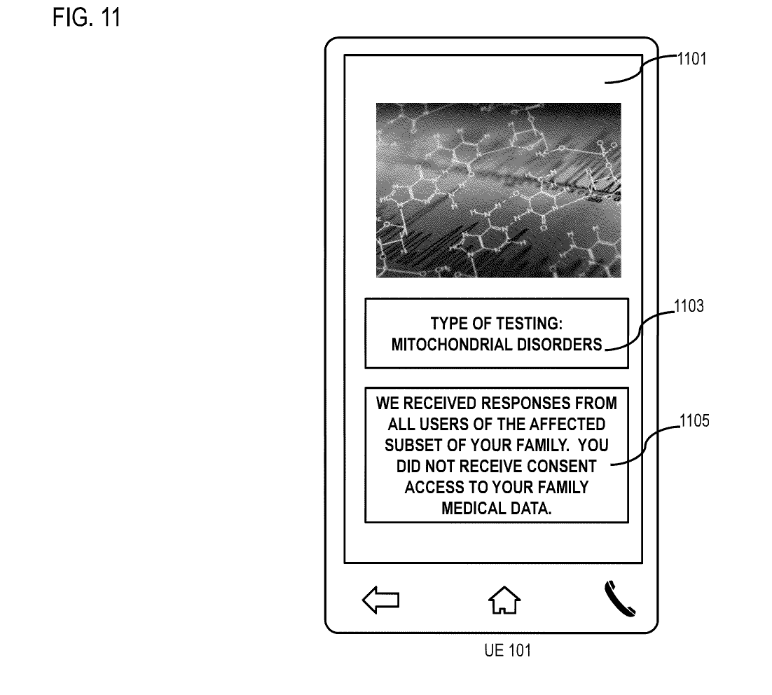

FIG. 11 is a diagram of the user interface utilized in the process of denying access to the medical data based on the aggregate response to the user that requested access, according to one example embodiment. In this scenario, at least one of the affected family members negatively responded to the request by consenting to access the medical data. As shown in FIG. 11, the notification [1101] includes the results of the request [1105] with respect to the medical data requested for the genetic test characteristic [1103]. The results of the request [1105] do not identify any of the affected members and corresponding responses based on the subset privacy policy. Accordingly, the notification [1101] maintains the confidentiality of the subset.

The processes described herein for determining consent to consent to access medical data associated with at least one genetic test characteristic based on an aggregate response for a subset of one or more users may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

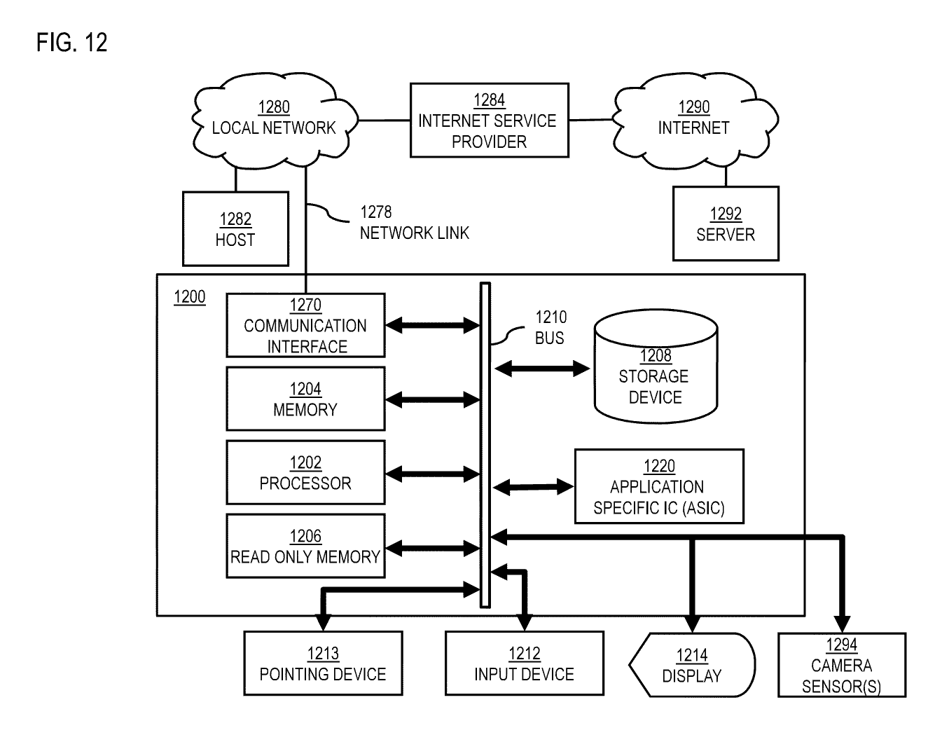

FIG. 12 illustrates a computer system 1200 upon which an embodiment of the invention may be implemented. Although computer system 1200 is depicted with respect to a particular device or equipment, it is contemplated that other devices or equipment (e.g., network elements, servers, etc.) within FIG. 12 can deploy the illustrated hardware and components of system 1200. Computer system 1200 is programmed (e.g., via computer program code or instructions) to determine consent to access medical data associated with at least one genetic test characteristic based on an aggregate response for a subset of one or more users as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of determining consent to access medical data associated with at least one genetic test characteristic based on an aggregate response for a subset of one or more users.

A bus 1210 includes one or more parallel conductors of information so that information is transferred quickly among devices coupled to the bus 1210. One or more processors 1202 for processing information are coupled with the bus 1210.

A processor (or multiple processors) 1202 performs a set of operations on information as specified by computer program code related to determine consent to access medical data associated with at least one genetic test characteristic based on an aggregate response for a subset of one or more users. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1200 also includes a memory 1204 coupled to bus 1210. The memory 1204, such as a random access memory (RAM) or any other dynamic storage device, stores information including processor instructions for determining consent to access medical data associated with at least one genetic test characteristic based on an aggregate response for a subset of one or more users. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or any other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for determining consent to access medical data associated with at least one genetic test characteristic based on an aggregate response for a subset of one or more users, is provided to the bus 1210 for use by the processor from an external input device 1212, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT), a liquid crystal display (LCD), a light emitting diode (LED) display, an organic LED (OLED) display, a plasma screen, or a printer for presenting text or images, and a pointing device 1216, such as a mouse, a trackball, cursor direction keys, or a motion sensor, for controlling a position of a small cursor image presented on the display 1214 and issuing commands associated with graphical elements presented on the display 1214. In some embodiments, for example, in embodiments in which the computer system 1200 performs all functions automatically without human input, one or more of external input device 1212, display device 1214 and pointing device 1216 is omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of ASICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 105 for determining consent to access medical data associated with at least one genetic test characteristic based on an aggregate response for a subset of one or more users to the UE 101.

The term “computer-readable medium” as used herein refers to any medium that participates in providing information to processor 1202, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1208. Volatile media include, for example, dynamic memory 1204. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system 1200 can be deployed in various configurations within other computer systems, e.g., host 1282 and server 1292.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or any other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

FIG. 13 illustrates a chip set or chip 1300 upon which an embodiment of the invention may be implemented. Chip set 1300 is programmed to determine consent to access medical data associated with at least one genetic test characteristic based on an aggregate response for a subset of one or more users as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of providing user interface navigation information associated with the availability of functions. Chip set or chip 1300, or a portion thereof, constitutes a means for performing one or more steps of determining consent to access medical data associated with at least one genetic test characteristic based on an aggregate response for a subset of one or more users.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to determining consent to access medical data associated with at least one genetic test based on an aggregate response for a subset of one or more users. The memory 1305 also stores the data associated with or generated by the execution of the inventive steps.

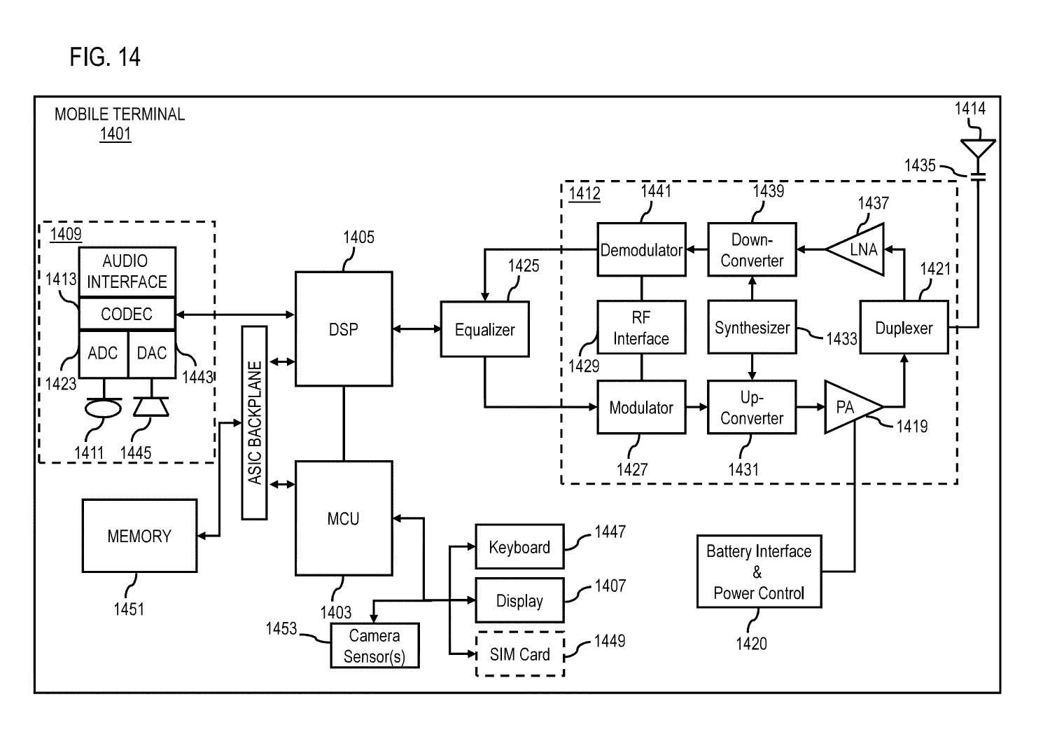

FIG. 14 is a diagram of exemplary components of a mobile terminal (e.g., handset) for communications, which is capable of operating in the system of FIG. 1, according to one embodiment. In some embodiments, mobile terminal 1401, or a portion thereof, constitutes a means for performing one or more steps of determining consent to access medical data associated with at least one genetic test characteristic based on an aggregate response for a subset of one or more users. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps of determining consent to access medical data associated with at least one genetic test characteristic based on an aggregate response for a subset of one or more users. The display 1407 includes display circuitry configured to display at least a portion of a user interface of the mobile terminal (e.g., mobile telephone). Additionally, the display 1407 and display circuitry are configured to facilitate user control of at least some functions of the mobile terminal. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403 which can be implemented as a Central Processing Unit (CPU).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 to determine consent to access medical data associated with at least one genetic test characteristic based on an aggregate response for a subset of one or more users. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of a response from each user of a subset of one or more users from a group of one or more users sharing a common genealogical relationship in response to a notification from a user from the group requesting consent to access medical data related to at least one test genetic test characteristic, one or more user privacy settings, one or more group privacy settings, or a combination thereof to determine a privacy policy for the subset; and
at least one determination of an aggregate response for the subset from the response from each user of the subset based on the privacy policy; and
a processing of the aggregate response to determine whether the subset consented to access the medical data.

2. A method of claim 1, wherein the (1) data and/or (2) information and/or (3) at least one signal are further based, at least in part, on the following:
a processing of at least one request related to consent to access the medical data associated with the at least one genetic test characteristic from the user from the group requesting consent;
at least one determination of one or more defined relationships based, at least in part, on the at least one genetic test characteristic; and
at least one determination of the subset of one or more users from the group corresponding to the one or more defined relationships.

3. A method of claim 2, wherein the (1) data and/or (2) information and/or (3) at least one signal are further based, at least in part, on the following:
at least one determination of test information associated with the at least one genetic test characteristic, the test information including the one or more defined relationships, one or more genetic tests and/or analyses, one or more of privacy consequences, one or more of possible test results, one or more sequence variation, or a combination thereof,
wherein the notification includes the test information.

4. A method of claim 1, wherein the (1) data and/or (2) information and/or (3) at least one signal are further based, at least in part, on the following:
a processing of contact information related to each user of the subset, one or more user privacy settings relating to each user of the subset, one or more group privacy settings for the group, or a combination thereof to cause the notification to be transmitted to one or more user devices associated with each user of the subset of users.

5. A method of claim 1, wherein the (1) data and/or (2) information and/or (3) at least one signal are further based, at least in part, on the following:
a processing of the response from each user of the subset to determine a response value;
a processing of the response value from each user of the subset to determine an aggregate response value for the subset; and
at least one determination of the aggregate response based, at least in part, on the aggregate response value.

6. A method of claim 1, wherein the privacy policy for the subset dictates whether the response provided by and/or an identity of each user of the subset is concealed.

7. A method of claim 1, wherein:
the user privacy settings for each user of the subset includes a public key; and
the (1) data and/or (2) information and/or (3) at least one signal are further based, at least in part, on the following:
an encryption of the notification for each user of the subset by the public key.

8. A method of claim 1, wherein:
each response is encrypted;
the (1) data and/or (2) information and/or (3) at least one signal are further based, at least in part, on the following:
at least one determination of the aggregate response for the subset directly from each encrypted response.

9. A method of claim 1, wherein the (1) data and/or (2) information and/or (3) at least one signal are further based, at least in part, on the following:
a transmission of a notification to the user requesting consent based, at least in part, on the aggregate response.

10. A method of claim 1, wherein the medical data for a user of the group includes medical history, genetic data, one or more results of genetic analysis and/or screening, or a combination thereof.

11. An apparatus comprising:
at least one processor; and
at least one memory including computer code for one or more programs,
the at least one memory and the computer program code configured to, with the at least one processor, cause the apparatus to perform at least the following:
process and/or facilitate a processing of a response from each user of a subset of one or more users from a group of one or more users sharing a common genealogical relationship in response to a notification from a user from the group requesting consent to access medical data related to at least one test genetic test characteristic, one or more user privacy settings for each user of the subset, one or more privacy settings for the group, or a combination thereof to determine a privacy policy for the subset; and
determine an aggregate response for the subset from the response from each user of the subset based on the privacy policy; and
process and/or facilitate a processing of the aggregate response to determine whether the subset consented access to the medical data.

12. An apparatus of claim 11, wherein the apparatus is further caused to:
process and/or facilitate a processing of at least one request related to consent to access the medical data related to the at least one test genetic test characteristic from the user from the group requesting consent;
determine the one or more defined relationships based, at least in part, on the at least one genetic test characteristic; and
determine the subset of one or more users from the group corresponding to the one or more defined relationships.

13. An apparatus of claim 12, wherein the apparatus is further caused to:
determine test information associated with the at least one genetic test characteristic, the test information including the one or more defined relationships, one or more genetic tests and/or analyses, one or more of privacy consequences, one or more of possible test results, one or more sequence variation, or a combination thereof,
wherein the notification includes the test information.

14. An apparatus of claim 11, wherein the apparatus is further caused to:
process and/or facilitate a processing of contact information related to each user of the subset, one or more user privacy settings relating to each user of the subset, one or more group privacy settings for the group, or a combination thereof to cause the notification to be transmitted to one or more user devices associated with each user of the subset of users.

15. An apparatus of claim 11, wherein the apparatus is further caused to:
process and/or facilitate a processing of a response to the notification from each user of the subset to determine a response value;
process and/or facilitate a processing of each response value from each user of the subset to determine an aggregate response value for the subset; and
determine the aggregate response based, at least in part, on the aggregate response value.

16. An apparatus of claim 11, wherein the privacy policy for the subset dictates whether each response for and/or identity of each user of the subset is concealed.

17. An apparatus of claim 11, wherein:
the user privacy settings for each user of the subset includes a public key; and
the apparatus is further caused to:
cause, at least in part, an encryption of the notification for each user of the subset by the public key.

18. An apparatus of claim 11, wherein:
each response is encrypted;
the apparatus is further caused to:
determine the aggregate response for the subset directly from each encrypted response.

19. An apparatus of claim 11, wherein the apparatus is further caused to:
cause, at least in part, a transmission of a notification to the user requesting consent based, at least in part, on the aggregate response.

20. An apparatus of claim 11, wherein the medical data for a user of the group includes medical history, genetic data, one or more results of genetic analysis and/or screening, or a combination thereof.

21.-48. (canceled)
